(19) United States
(12) Patent Application Publication
(10) Pub. No.: US 2009/0195878 A1
(43) Pub. Date: Aug. 6, 2009

(54) LINEAR SWING ACTUATOR

(75) Inventor: Yuichi KUROSAWA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/365,332

(22) Filed: Feb. 4, 2009

(30) Foreign Application Priority Data
Feb. 4, 2008 (JP) 2008-023804

(51) Int. Cl. G02B 27/64; H02K 41/035; G02B 7/02

(52) U.S. Cl. 359/557; 359/824; 310/12.16

(57) ABSTRACT

There is provided a linear swing actuator, which is provided with a multipolar magnet arranged with one magnetic pole in a central portion and its respective opposite magnetic poles at both ends thereof along a length direction; and a single coil arranged to be relatively movable in the length direction face to face with respect to the multipolar magnet. In this configuration, a distance between the magnetic pole in the central portion and each of the magnetic poles at the both ends is arranged to be shorter than a dimension in the length direction of the coil.

### BACKGROUND OF THE INVENTION

The present invention relates to a linear swing actuator arranged with a magnet and a coil to be capable of linear movement utilizing magnetic force, particularly to a linear swing actuator being capable of specifying a swinging range.

Linear actuator is also referred to as linear type motor (linear motor), and is configured to move either of a magnet or a coil utilizing magnetic force which is generated by energizing a coil arranged in a magnetic field generated by a magnet. For example, a linear actuator which is configured that a plurality of permanent magnets are arranged in series face to face with the same polarity each other so as to form a movable element being alternately arranged with S-poles and N-poles, and a coil as a stator is arranged in a magnetic field region generated by the permanent magnets located outer periphery of the movable element, is proposed in Japanese Patent Provisional Publication No. 2007-282475 (hereafter, referred to as JP 2007-282475A). That is, by controlling direction of electric currents to be applied on the coil, a magnetic force in a predetermined direction is generated according to the magnetic field of the permanent magnets, and then the permanent magnets as a movable element is to be linearly moved by the magnetic force. Although almost the same as JP 2007-282475A, permanent magnets are arranged to be a stator and a coil is arranged to be a movable element in a linear actuator disclosed in Japanese Patent Provisional Publication No. H10-313566 (hereafter, referred to as JP H10-313566A).

### SUMMARY OF THE INVENTION

Both linear actuators disclosed in JP 2007-282475A and JP H10-313566A are premised that the movable element is to be moved relatively a long distance (dimension), therefore, it is arranged with S-poles and N-poles alternately along the length direction thereof, and the coil is arranged as a three-phase coil to which respectively applying different phase electric currents. For example, in the case of Japanese Patent Provisional Publication No. 10-313566 where a coil is arranged as a movable element, three coils are integrally arranged along the length direction (hereinafter, the same as moving direction) to compose a three-phase coil, and each of the coils is moved by controlling electric current to be applied to the three-phase coil in a necessary sequence, and by sequentially switching the coils to be generating magnetic force so as to be moved face to face with a plurality of S-poles and N-poles of the permanent magnets arranged as a stator. The linear actuator described above is moved by applying an electric current to any one or two of the three coils which compose the three-phase coil. Accordingly, driving force can be obtained only ⅓ or ⅔ of the overall length of the three-phase coil that becomes difficult to obtain a large driving force when downsizing the actuator. Additionally, it has necessity of a special drive circuit, commonly a driver IC, in order to control electric current to be applied to the three-phase coil in a sequence, whereby circuit configuration of the drive circuit will be complicated and it will become obstacle to aim to realize a low cost.

Aspects of the present invention have been made to advantageously provide a linear swing actuator enlarged in dimension in the length direction of the coil so as to enlarge the driving force and to enable the drive circuit to be simplified.

According to an aspect of the invention, there is provided a linear swing actuator, which is provided with a multipolar magnet arranged with one magnetic pole in a central portion and its respective opposite magnetic poles at both ends thereof along a length direction; and a single coil arranged to be relatively movable in the length direction face to face with respect to the multipolar magnet. In this configuration, a distance between the magnetic pole in the central portion and each of the magnetic poles at the both ends is arranged to be shorter than a dimension in the length direction of the coil.

According to the above described configuration, a linear swing actuator having a large driving force corresponding to the dimension in the length direction of the coil and a simplified drive circuit can be obtained.

In at least one aspect, the multipolar magnet is arranged with a pair of permanent magnets to be connected at the same polarity face to face with each other along the length direction.

In at least one aspect, the multipolar magnet is arranged as a multipolar magnetized magnet of a rod-shaped isotropic magnet material being magnetized into S-pole and N-pole along the length direction at a necessary interval.

In at least one aspect, the linear swing actuator is configured as an actuator for a lens mechanism to move a photographing lens of a camera in the optical axis direction thereof.

According to another aspect of the invention, there is provided a linear swing actuator, which is provided with a yoke being extended in a length direction and arranged with magnets at both ends thereof, and a single coil arranged to be relatively movable in the length direction face to face with respect to the yoke. In this configuration, a distance between each end portion of the coil along the length direction and each magnetic pole formed with the magnets at the both ends is arranged to be shorter than a dimension in the length direction of the coil in a state where the coil is located at a central portion of the yoke in the length direction.

According to the above described configuration, a linear swing actuator having a large driving force corresponding to the dimension in the length direction of the coil and a simplified drive circuit can be obtained.

In at least one aspect, the magnets at the both ends comprise permanent magnets in which their respective poles having the same polarity are arranged to be face to face with each other along the length direction.

In at least one aspect, the magnets at the both ends comprise electric magnets in which their respective polar directions are variable.

In at least one aspect, the linear swing actuator is configured as an actuator to move a shake correcting lens of a camera in the perpendicular direction with respect to the optical axis thereof.

### BRIEF DESCRIPTION OF THE ACCOMPANYING DRAWINGS

FIGS. 1A and 1B respectively show a conceptual perspective view and a conceptual section diagram of a linear swing actuator according to a first embodiment.

FIGS. 2A-2C show conceptual section diagrams for illustrating operation of the first embodiment.

FIG. 3 shows a conceptual section diagram for illustrating a modified example of the first embodiment.

FIGS. 4A and 4B respectively show a perspective view and a vertical section diagram of a lens mechanism to which an actuator in the first embodiment is applied.

FIGS. 5A-5C respectively show a conceptual perspective view and conceptual section diagrams of a linear swing actuator according to a second embodiment.

FIGS. 6A-6B show conceptual section diagrams for illustrating a modified example of the second embodiment.

FIG. 7 shows a perspective view of a shake correcting mechanism to which an actuator in the second embodiment is applied.

### DETAILED DESCRIPTION OF THE EMBODIMENTS

Hereinafter, embodiments according to the invention are described with reference to the accompanying drawings.

In the first linear swing actuator according to the invention, the multipolar magnet may be arranged with a pair of permanent magnets to be connected at the same polarity face to face with each other along the length direction. Or, the multipolar magnet may be arranged as a multipolar magnetized magnet of a rod-shaped isotropic magnet material being magnetized into S-pole and N-pole along the length direction at a necessary interval. In this manner, the multipolar magnet of a first linear swing actuator can be configured easily. Therefore, for example, by configuring the first linear swing actuator as an actuator for a lens mechanism to move a photographing lens of a camera in the optical axis direction thereof, a small-sized, light-weighted, and low cost camera can be realized.

In a second linear swing actuator according to the invention, the magnets at the both ends may include permanent magnets in which their respective poles having the same polarity are arranged to be face to face with each other along the length direction. Or, the magnet at the both ends may include electric magnets in which their respective polar directions are variable. In this manner, the multipolar magnet of the second linear swing actuator can be configured easily. Therefore, for example, by configuring the second linear swing actuator as an actuator to move a shake correcting lens of a camera in the perpendicular direction with respect to the optical axis thereof, a small-sized, light-weighted, and low cost camera can be realized.

### First Embodiment

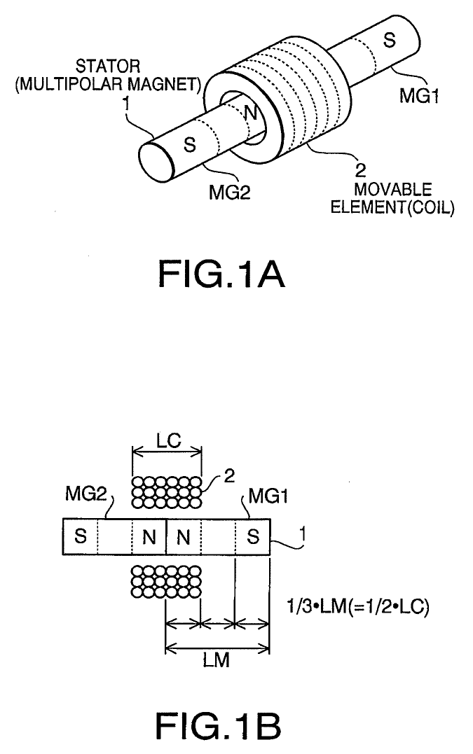

Hereinafter, referring to accompanying drawings, a first embodiment of the present invention will be described. FIG. 1A and FIG. 1B are a conceptual perspective view and a conceptual section diagram of a linear swing actuator. An example of the linear actuator is shown here that a cylindrical rod shaped multipolar magnet 1 is arranged as a stator, and a single coil 2 which is arranged around the long axis of the multipolar magnet 1 to linearly move along the length direction of the multipolar magnet 1 as a movable element. The coil 2 is formed with a single conducting wire or a plurality of conducting wires to be wound around in a single direction so as to encircle the multipolar magnet 1 in a concentric cylindrical shape, and an electric current can be applied to the conducting wire with switching the electric current in one direction and another as will be described below, by a drive circuit, illustration is omitted. Here, the single coil 2 according to the present invention means that an electric current to be applied to each conducting wire is the same even when a plurality of conducting wires are wound around, and the coil composed of each of the conducting wire is arranged as mechanically integrated and is moved in one piece. In this regard, the dimension in the length direction of the coil 2 is expressed by LC.

The multipolar magnet 1 is arranged with two SN magnetized short cylindrical rod shaped permanent magnets MG1 and MG2 along the length direction, where their same polarity poles are tightly fayed face to face with each other to be integrated. In this embodiment, respective N-poles are tightly fayed face to face with each other. Examples of a method of integration include a method of adhering both using adhesive, and a method of fixing the both magnets on a supporting member which is extended in the length direction. Accordingly, the multipolar magnet 1 is formed that S-poles are arranged at the both end portions along the length direction, and N-poles are arranged in the central portion along the length direction. In this regard, each dimension LM in the length direction of the two permanent magnets MG1 and MG2 is set to 1.5 times as long as the dimension LC of the coil 2, that is, LM= 3/2·LC. Therefore, in the multipolar magnet 1, as indicated by the broken lines in FIG. 1B, approximately ⅓ (=⅔·LM=LC) region in the center along the length direction is N-polar magnetic pole, approximately ⅙ (=⅓·LM) regions at the respective ends are S-polar magnetic poles, and approximately ⅙ (=⅓·LM) length distances respectively between the N-poles and S-poles are formed.

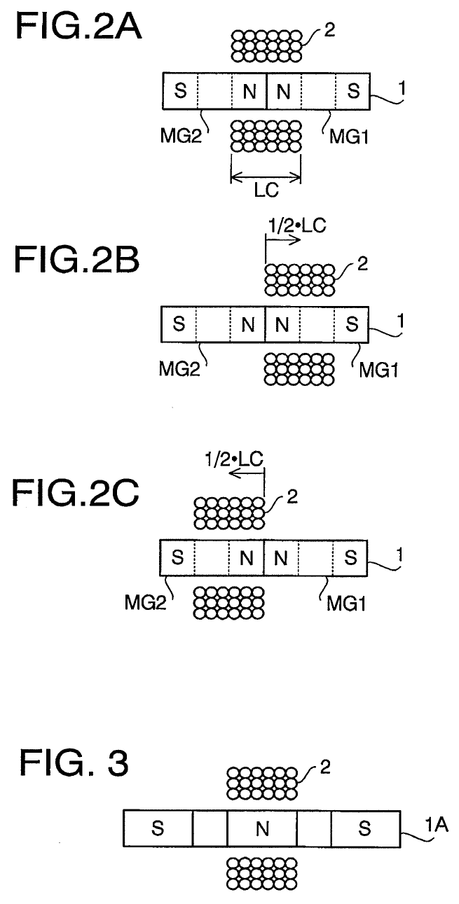

As for the linear actuator according to the first embodiment, in the multipolar magnet 1, a radial magnetic field is formed around N-pole toward the radial direction, and a centripetal magnetic field is formed around S-pole toward the opposite direction to the above. When the movable coil 2 is in the position shown in FIG. 1A, that is the position shown in FIG. 2A, and an electric current in one direction is applied to the coil 2, a rightward driving force is generated on the coil 2 here caused by the current direction in the coil 2 and the magnetic field by N-pole of the multipolar magnet 1 according to the Fleming's left-hand rule, whereby the coil 2 moves to the right as shown in FIG. 2B. However, since a magnetic field by S-pole exists at a right end region of the multipolar magnet 1, the rightward movement of the coil 2 is damped before the coil 2 is affected by the magnetic filed by S-pole at the right end region. Consequently, the coil 2 is to move a ½ length of the coil dimension LC, that is, a ½·LC. It is equal to the dimension up to the right end portion of the coil 2 reaches to S-pole. Therefore, the coil 2 is to move the distance dimension between the right end portion of the coil 2 and S-pole.

As described above, in the linear swing actuator according to the first embodiment, even though the length of the coil 2 is LC, the movement dimension of the coil 2 becomes ½·LC, in other words, the length dimension of the coil 2 can be set to double the movement dimension of the coil 2. Accordingly, the winding number of the coil 2 can be set to approximately double the winding number of the coil in JP H10-313566A, and the larger moving force, that is, driving force can be obtained than applying the same electric current thereto.

When applying an electric current in the opposite direction to the coil 2, the coil 2 (i.e., the movable coil) moves to the left as shown in FIG. 2C. In this case, it moves a ½·LC to the left of the position in FIG. 2A at the maximum. Though it comes near to stating the obvious, the movement dimension of the coil 2 is equal to the distance dimension between the left end portion of the coil 2 and S-pole. Accordingly, in the first embodiment, by alternately changing the direction of the electric current to be applied to the coil 2, the coil 2 is to perform reciprocating linear movement of a ½·LC dimension to the right and left centering on the position in FIG. 2A, whereby the linear swing actuator can be configured. Further, by controlling the amount and direction of the electric current to be applied to the coil 2, moving amount of the movable coil also can be changed. Since in the actuator according to the first embodiment, it only needs to apply a single phase electric current to the coil 2, the drive circuit can be simplified.

FIG. 3 is a conceptual configuration diagram showing a modified example of a linear swing actuator according to the first embodiment. In the modified example, the multipolar magnet as a stator is arranged with a multipolar magnetized magnet 1A being composed of a cylindrical rod shaped isotropic magnet material formed with magnetized regions each of which is magnetized into S-pole and N-pole along the axial direction thereof at a necessary pitch distance. And a cylindrical coil 2 is arranged around the multipolar magnetized magnet 1A. Configuration of the coil 2 is the same as that in the first embodiment. In this regard, each the length dimension of the magnetized region being magnetized into S-pole and N-pole in the multipolar magnetized magnet 1A is arranged to be equal to the dimension LC in the length direction of the coil 2, and the distance along the length direction between N-pole in the center and S-pole region at both ends is arranged to be ½·LC. It becomes substantially the same configuration as the first embodiment shown in FIG. 1B. Accordingly, even when the multipolar magnetized magnet 1A is used as a stator, the linear swing actuator capable of reciprocating in a length of ½ of the dimension LC at the maximum, in the length direction of the coil 2 similarly to the first embodiment, can be configured.

Though it comes near to stating the obvious, in the linear swing actuator according to the first embodiment and the modified example, the center portion in the multipolar magnet 1 or the multipolar magnetized magnet 1A may be arranged to be S-pole, and the both end portions may be arranged to be N-pole. Also, the coil 2 may be arranged as a stator, and the multipolar magnet 1 or the multipolar magnetized magnet 1A may be arranged as a movable element to form a linear swing actuator.

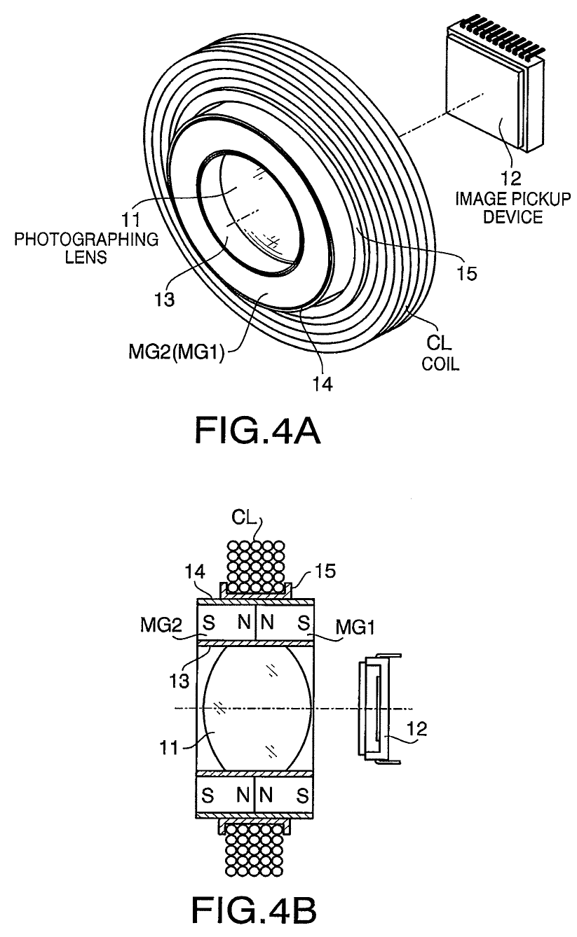

FIGS. 4A and 4B show an application example applying a linear swing actuator according to the first embodiment to a lens mechanism of a camera. FIG. 4A is an perspective view and FIG. 4B is a vertical section diagram. It is a simple-type camera provided with a photographing lens 11 and an image pickup device 12 in a camera body, not shown in the figure, where a subject image is taken by the photographing lens 11 and is formed in the image pickup device 12. The photographing lens 11 is supported by a short cylindrical shaped lens holding frame 13 therein, and a pair of short cylindrical shaped permanent magnets MG1 and MG2 which are respectively magnetized into S-poles and N-poles along the optical axis direction thereof are arranged outside the lens holding frame 13 so that the same polarity poles are tightly fayed face to face with each other being supported and fixed by the lens holding frame 13 and a magnet holding cylinder 14 located outside periphery of the lens holding frame 13.

And at the outer periphery of the magnet holding cylinder 14, a cylindrical shaped coil bobbin 15 which is shorter than the magnet holding cylinder 14 in the dimension along the optical axis direction is provided to be capable of relatively sliding in the axial direction of the cylinder with respect to the magnet holding cylinder 14, and a coil CL is wound around the outer peripheral surface. The coil CL is supported and fixed in the camera body, and an electric current of an optional value is applied to be capable of switching in one direction and another by a control unit, not shown in the figure.

According to the lens mechanism, the pair of permanent magnets MG1 and MG2 arranged along the optical axis direction can be configured as the multipolar magnet of the first embodiment, and by controlling the current direction and current value of the electric current to be applied to coil CL arranged around the multipolar magnet along the axial direction thereof, driving force in the axial direction of the cylinder is generated between the coil CL and the permanent magnets MG1 and MG2 as illustrated in FIGS. 2A-2C, whereby the permanent magnets MG1 and MG2, and the lens holding frame 13 and the photographing lens 11 which are integrated therewith are moved in the optical axis direction, and stopped at an optional position.

Therefore, by controlling electric current as described above, variably controlling position of the photographing lens 11 with respect to the image pickup device 12 and adjusting focus on a subject to be formed in the image pickup device 12 become enabled. In the lens mechanism, since main component portions for moving the photographing lens 11 in the optical axis direction can be configured with only the coil CL and the permanent magnets MG1 and MG2, it can be configured in light weight and small size, and especially applying it to a slim-type camera becomes enabled. In this regard, when using a multipolar magnetized magnet composed of an isotropic magnet material instead of the pair of permanent magnets MG1 and MG2, the necessary multipolar magnet becomes a single, and further reducing parts count becomes enabled. And it is needless to mention that configuration of the drive circuit as a current source to be applied to the coil CL can be simplified.

### Second Embodiment

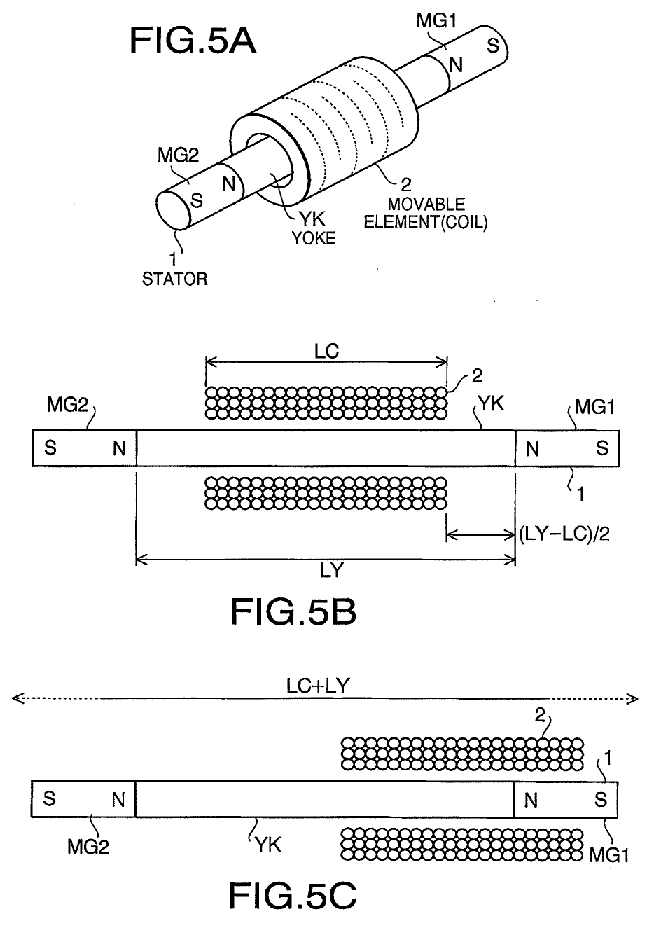

FIG. 5A and FIG. 5B are a conceptual perspective view and conceptual section diagrams of a linear swing actuator according to a second embodiment. It is configured here a pair of cylindrical rod shaped permanent magnets MG1 and MG2 are arranged that a cylindrical rod shaped yoke YK having the same diameter therewith made of a soft magnetic material is placed in between them along the length direction, and they are tightly fayed each other to be integrated into one as a stator. In this embodiment, each of the permanent magnets MG1 and MG2 is face to face with the same polarity in S-pole or N-pole, N-pole here, however, both of the permanent magnets MG1 and MG2 are away from each other across the yoke YK.

Accordingly, occurrence of their mutual repulsion is very little, they and the yoke YK attract each other, therefore, both of the permanent magnets MG1 and MG2 can be easily integrated with the yoke YK by adhesive. And, a cylindrical shaped single coil 2 is concentrically arranged around the yoke YK as a movable element. The coil 2 is configured as a single coil similarly to that in the first embodiment, and an electric current in one direction can be applied thereto. In this regard, the dimension in the length direction of the coil 2 is expressed by LC, and is arranged to be shorter than the dimension LY in the length direction of the yoke YK. Therefore, the distance (LY−LC)/2 between each end of the coil 2 and each N-pole of the permanent magnets MG1 and MG2 is shorter than the dimension LC of the coil 2.

In the linear swing actuator according to the second embodiment, magnetic flux caused by the permanent magnets MG1 and MG2 at the both ends of the yoke YK is transmitted through the yoke YK, a radial magnetic field is generated along the length direction of the yoke YK. Accordingly, when an electric current is applied to the coil 2, a driving force along the length direction is generated on the coil 2 according to the Fleming's left-hand rule, a rightward driving force is generated here as shown in FIG. 5C, and the coil 2 moves to the right. When the coil 2 is moved more to the right of the figure, though not shown in the figure, and when the left end portion of the coil 2 comes to the region where a magnetic field is generated by N-pole of the right permanent magnet MG1, the coil length relating to N-pole and that to S-pole become equal. For this reason, in such a case, the movement of the coli 2 is damped immediately before the left end portion of the coil 2 comes to the region where a magnetic field is generated by N-pole of the right permanent magnet MG1. On the other hand, though illustration is omitted, when applying an electric current in the opposite direction to the coil 2, the coil 2 moves to the left. In this case, the movement of the coil 2 is damped immediately before the coil 2 is moved to the point that the right end portion of the coil 2 comes to the region where a magnetic field is generated by N-pole of the left permanent magnet MG2.

Accordingly, by applying an electric current alternately different in direction to the coil 2, the coil 2 is to be swingably moved while performing reciprocating linear movement along the yoke YK. The movement dimension during the swingable movement is a dimension added up the dimensions of coil 2 and the yoke YK as described above, that is, LY+LC. In this regard, in order to obtain an approximately regular driving force, the coil 2 is performed of reciprocating movement within the length LY of the yoke YK. Optionally, when the permanent magnets MG1 and MG2 at the both ends are respectively arranged to be face to face with different polarity, an actuator which is arranged to fix the coil 2 at the center of the yoke YK when energizing the coil 2 can be configured. That is, the linear swing actuator is configured that the coil 2 returns to the central position automatically even when the coil 2 is moved right and left by an external force. Consequently, since it only needs to apply a single phase electric current to the coil 2, the drive circuit can be simplified.

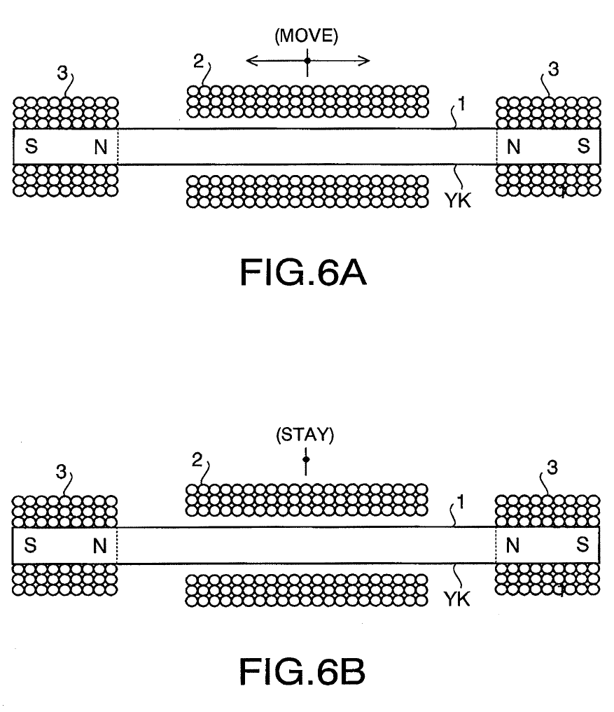

FIGS. 6A-6B show conceptual section diagrams of a modified example of a linear swing actuator according to the second embodiment. As shown in FIG. 6A, a stator is configured with a single cylindrical rod shaped yoke YK, and fixed coils 3 provided at the both end portions. The coil 2 as a movable element is the same as that in the second embodiment. Both of the end portions of the yoke YK are respectively magnetized by apply electric currents to the fixed coils 3. That is, a configuration in which the permanent magnets MG1 and MG2 at the both ends of the yoke YK in the second embodiment are replaced by electric magnets. Accordingly, when applying electric currents respectively in the opposite directions to the fixed coil 3, the fixed coil 3 are respectively magnetized in the opposite directions from each other so as to be face to face with the same polarity, whereby it becomes substantially the same configuration as the actuator composed of the permanent magnets MG1 and MG2 shown in FIG. 5B.

In the modified example, when applying electric currents respectively in the same direction to the fixed coil 3 at the both ends as shown in FIG. 6B, the fixed coil 3 are respectively magnetized in the same directions, whereby a magnetic field generated by the yoke YK is to be varied along the length direction. Accordingly, when applying an electric current to the coil 2, the coil 2 is moved to the central position in the length direction of the yoke YK to be fixed there. Consequently, according to the modified example, a linear swing actuator in which by controlling direction of electric currents to be applied to the fixed coils 3 and the coil 2, the coils can be moved to the respective positions to the right and left, or can be swingably moved between the right and left, while the coil 2 can be fixed at the central position along the length direction of the stator 1, can be configured.

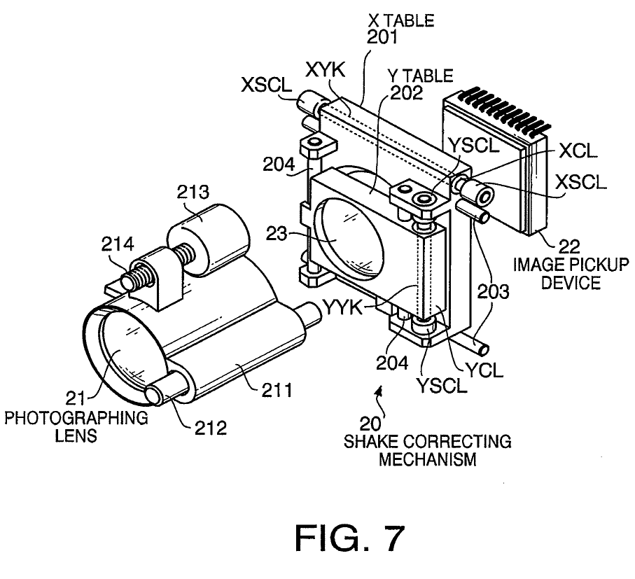

FIG. 7 is a perspective view of an application example applying a linear swing actuator according to the second embodiment to a shake correcting mechanism of a camera. The linear swing actuator is provided with a photographing lens 21, an image pickup device 22 for forming a subject image taken by the photographing lens 21, and a shake correcting mechanism 20 between the photographing lens 21 and the image pickup device 22. In a portion of a lens frame 211 which supports a photographing lens 21, a lens guide 212 being extended in the optical axis direction is inserted through, whereby the lens frame 211 is movably supported in the optical axis direction by the lens guide 212. And another portion of the lens frame 211 is threadably engaged with a lead screw 214 which is axially rotated by a stepping motor 213 being fixed to a camera body, not shown in the figure. Accordingly, the lens frame 211, together with the photographing lens 21, is moved in the optical axis direction by driving of the stepping motor 213, whereby adjusting focus on a subject to be formed in the image pickup device 22 become enabled.

The shake correcting mechanism 20 is provided with an X table 201 to be movable in the X direction that is supported at the upper and lower end portions by a pair of X table guides 203 extended in the horizontal direction (X direction) with the camera body and is perpendicularly arranged with respect to the optical axis; a Y table 202 to be movable in the Y direction that is supported at the right and left end portions by a pair of Y table guides 204 extended in the vertical direction (Y direction) being attached to the X table 201; and a shake correcting lens 23 which is supported by the Y table 202. The shake correcting lens 23 is configured to displace a subject image taken by the photographing lens 21 toward X direction and Y direction on the image formation surface of the image pickup device 22; to coordinate the displacement with camera shake occurring at the time of photographing, that is oscillation on the image formation surface so as to offset the displacement; and thereby correcting camera shakes.

In the upper end portion of the X table 201, an X coil XCL. is provided internally in the X direction, and a cylindrical rod shaped X yoke XYK which is supported by the camera body at the both ends is inserted in the X coil XCL. And, X fixed coils XSCL are respectively wound around both of the right and left end portions of the X yoke XYK to form electric magnets. Thus an X direction linear swing actuator is configured with the X yoke XYK, the X coil XCL, and the X fixed coils XSCL. In the right end portion of the Y table 202 in the figure, a Y coil YCL is provided internally in the Y direction, and a cylindrical rod shaped Y yoke YYK which is supported by the X table 201 at the both ends is also inserted. And, Y fixed coils YSCL are respectively wound around both of the upper and lower end portions of the Y yoke YYK to form electric magnets. Thus a Y direction linear swing actuator is configured with the Y yoke YYK, the Y coil YCL, and the Y fixed coils YSCL. In this regard, necessary control currents are applied to X coil XCL and X fixed coils XSCL, and Y coil YCL and Y fixed coils YSCL from a shake correcting circuit, not shown in the figure.

In the shake correcting mechanism, the shake correcting circuit excites both of the electric magnets of the X fixed coils XSCL which are paired at other than release time, toward the same direction similarly to the actuator shown in FIG. 6B. In the similar manner, the shake correcting circuit excites both of the electric magnets of the Y fixed coils YSCL toward the same direction. Consequently, when applying an electric current to the X coil XCL, the X coil XCL and the X table 201, which is integrated with the X coil XCL, are positioned at the center of the X yoke XYK along the length direction. On the other hand, when applying an electric current to the Y coil YCL, the Y coil YCL and the Y table 202, which is integrated with the Y coil YCL, are positioned at the center of the Y yoke YYK along the length direction. Thus, the shake correcting lens 23 supported by the Y table 202 is positioned on the optical axis of the photographing lens 21, and the position becomes image forming center of the image pickup device 22.

At the time of release for photographing, if oscillation caused by a camera shake in a camera body, the shake correcting circuit detects an X direction component and a Y direction component of the oscillation, and controls electric current to be applied to each of the X and Y coils, that is, each of the coils XCL and YCL, and each of the fixed coils XSCL and YSCL based of the detection. The shake correcting circuit excites both of the electric magnets of the pair of X fixed coils XSCL respectively toward the opposite directions similarly to the actuator shown in FIG. 6A. In the similar manner, the shake correcting circuit excites both of the electric magnets of the Y fixed coils YSCL respectively toward the opposite directions.

Then, electric currents are applied to the respective coils toward the direction to move the X coil XCL and Y coil YCL so as to offset the detected X direction component and Y direction component, respectively. Therefore, the X coil XCL and the X table 201, which is integrated with the X coil XCL, moves in the X direction with respect to the camera body so as to offset the X component, and the Y coil YCL and the Y table 202, which is integrated with the Y coil YCL, moves in the Y direction with respect to the X table so as to offset the Y component. Consequently, the shake correcting lens 23 moves in the X direction and Y direction with respect to the optical axis of the photographing lens 21, and a subject image to be performed image formation in the image pickup device 22 can be kept in a certain position regardless of oscillation of camera shake, and thereby correcting camera shakes.

As described above, by applying the linear swing actuator of the second embodiment, the shake correcting lens 23 can be kept in the optical axis position other than release time, and can be controlled movement to the X and Y directions so as to offset oscillation caused by camera shakes at the release time, only by controlling energization to the coils XCL and YCL, and the fixed coils XSCL and YSCL, and therefore the shake correcting mechanism can be realized. Since the shake correcting mechanism, each of the X direction and Y direction linear swing actuators can be configured with a coil, a yoke, and fixed coils, whereby configuring in small size and light weight, and applying it to a shake correcting mechanism of a small-sized camera can be realized.

Though needless to mention, the linear swing actuator according to the first embodiment and the second embodiment can be applied not only to the lens mechanism and the shake correcting mechanism in a camera but also to other various mechanisms as an actuator performing reciprocating linear movement in a fine dimension in various devices aiming to reduce size and weight.

According to the above described embodiment, a linear swing actuator having a large driving force corresponding to the dimension in the length direction of the coil and a simplified drive circuit can be obtained. Since, it can be formed of a coil and permanent magnet; or a coil, yoke, and permanent magnet or fixed coil; a small-sized, light-weighted, low cost linear swing actuator can be also obtained.

This application claims priority of Japanese Patent Application No. P2008-023804, filed on Feb. 4, 2008. The entire subject matter of the application is incorporated herein by reference.

What is claimed is:

1. A linear swing actuator, comprising:
a multipolar magnet arranged with one magnetic pole in a central portion and its respective opposite magnetic poles at both ends thereof along a length direction; and
a single coil arranged to be relatively movable in the length direction face to face with respect to the multipolar magnet,
wherein a distance between the magnetic pole in the central portion and each of the magnetic poles at the both ends is arranged to be shorter than a dimension in the length direction of the coil.

2. The linear swing actuator according to claim 1, wherein the multipolar magnet is arranged with a pair of permanent magnets to be connected at the same polarity face to face with each other along the length direction.

3. The linear swing actuator according to claim 1, wherein the multipolar magnet is arranged as a multipolar magnetized magnet of a rod-shaped isotropic magnet material being magnetized into S-pole and N-pole along the length direction at a necessary interval.

4. The linear swing actuator according to claim 1, wherein the linear swing actuator is configured as an actuator for a lens mechanism to move a photographing lens of a camera in the optical axis direction thereof.

5. A linear swing actuator, comprising:
a yoke being extended in a length direction and arranged with magnets at both ends thereof; and
a single coil arranged to be relatively movable in the length direction face to face with respect to the yoke,
wherein a distance between each end portion of the coil along the length direction and each magnetic pole formed with the magnets at the both ends is arranged to be shorter than a dimension in the length direction of the coil in a state where the coil is located at a central portion of the yoke in the length direction.

6. The linear swing actuator according to claim 5, wherein the magnets at the both ends comprise permanent magnets in which their respective poles having the same polarity are arranged to be face to face with each other along the length direction.

7. The linear swing actuator according to claim 5, wherein the magnets at the both ends comprise electric magnets in which their respective polar directions are variable.

8. The linear swing actuator according to claim 5, wherein the linear swing actuator is configured as an actuator to move a shake correcting lens of a camera in the perpendicular direction with respect to the optical axis thereof.
